(19) United States
(12) Patent Application Publication
(10) Pub. No.: US 2024/0223998 A1
(43) Pub. Date: Jul. 4, 2024

(54) LOCATION SHARING SERVER, LOCATION SHARING SYSTEM AND LOCATION SHARING METHOD OF VEHICLE

(71) Applicants: HYUNDAI MOTOR COMPANY, SEOUL (KR); KIA CORPORATION, SEOUL (KR)

(72) Inventor: Hye Won You, Seoul (KR)

(21) Appl. No.: 18/369,406

(22) Filed: Sep. 18, 2023

(30) Foreign Application Priority Data
Jan. 3, 2023 (KR) 10-2023-0000814

(51) Int. Cl. H04W 4/029; H04W 4/40

(52) U.S. Cl. CPC H04W 4/029; H04W 4/40

(57) ABSTRACT

A location sharing server includes a memory and a processor configured to receive a location sharing request with a call number of a mobile terminal from a first vehicle, to request a second vehicle to transmit driving state information of the second vehicle based on a vehicle identification number corresponding to the call number, and to perform location sharing based on the driving state information such that a location of the first vehicle is shared with the second vehicle.

### CROSS REFERENCE TO RELATED APPLICATIONS

This application claims the benefit of Korean Patent Application No. 10-2023-0000814, filed on Jan. 3, 2023, in the Korean Intellectual Property Office, the disclosure of which is incorporated herein by reference.

### BACKGROUND

### 1. Technical Field

The present disclosure relates to a location sharing server, a location sharing system and a location sharing method of a vehicle, and more particularly to a location sharing server, a location sharing system and a location sharing method of a vehicle which are capable of providing an inter-vehicle location sharing service based on a call number of a mobile terminal.

### 2. Description of the Related Art

A user of a location sharing service may request location sharing to a mobile terminal or a vehicle of a counterpart through a location sharing service, and may share his current vehicle location with the counterpart based on a response to the request.

In a scheme in which a location sharing requester selects a node of one of a mobile terminal or a vehicle of a counterpart, and the selected node and the vehicle location of the requester are shared, however, responsiveness and convenience of a location sharing service for the counterpart may be degraded.

For example, when the location sharing requester requests location sharing to a mobile terminal of the counterpart, responsiveness of the location sharing service for the counterpart may be degraded under the condition that the vehicle of the counterpart is in a driving state, because it is difficult for the location sharing requester to identify whether or not the vehicle of the counterpart is in a driving state.

In addition, when the counterpart rides in a vehicle in a state in which location sharing is carried out between a vehicle of the location sharing requester and the mobile terminal of the counterpart, the counterpart should identify a location of the requester through his mobile terminal. For this reason, convenience of the location sharing service for the counterpart may be degraded.

The above matters disclosed in this section are merely for enhancement of understanding of the general background of the disclosure and should not be taken as an acknowledgement or any form of suggestion that the matters form the related art already known to a person skilled in the art.

### SUMMARY

Therefore, the present disclosure has been made in view of the above problems, and it is an object of the present disclosure to provide an inter-vehicle location sharing service to a vehicle of a location sharing requester based on a call number of a mobile terminal of a counterpart receiving a location sharing request from the location sharing requester in accordance with whether or not a vehicle of the counterpart is in a driving state, when the vehicle of the location sharing requester requests location sharing to the mobile terminal of the counterpart.

Objects of the present disclosure are not limited to the above-described objects, and other objects of the present disclosure not yet described will be more clearly understood by those skilled in the art from the following detailed description.

In accordance with an aspect of the present disclosure, the above and other objects can be accomplished by the provision of a location sharing server including a memory, and a processor configured to receive a location sharing request with a call number of a mobile terminal from a first vehicle, to request a second vehicle to transmit driving state information of the second vehicle, based on a vehicle identification number corresponding to the call number, and to perform location sharing based on the driving state information such that a location of the first vehicle is shared with the second vehicle.

The processor may request a first external server to transmit a vehicle ID corresponding to the call number, thereby receiving the vehicle ID, and may request a second external server to transmit the vehicle identification number corresponding to the vehicle ID, thereby receiving the vehicle identification number.

The processor may request the first external server to transmit user information corresponding to the call number, thereby receiving the user information.

The processor may transmit the location sharing request of the first vehicle upon determining that the second vehicle is in a driving state, based on the driving state information, and may transmit the location of the first vehicle to the second vehicle upon receiving an approval response of the second vehicle to the location sharing request.

The processor may transmit a location of the second vehicle to the first vehicle upon receiving the approval response of the second vehicle to the location sharing request.

The processor may transmit the location sharing request of the first vehicle to the mobile terminal, based on the call number, and may transmit the location of the first vehicle to the mobile terminal upon receiving an approval response of the mobile terminal to the location sharing request.

The processor may transmit the location sharing request to the mobile terminal through a short message service (SMS) including uniform resource locator (URL) link information.

In accordance with another aspect of the present disclosure, there is provided a location sharing system including a vehicle configured to transmit a location sharing request with a call number of a mobile terminal, and a location sharing server configured to receive the location sharing request with the call number from the vehicle, to request another vehicle to transmit driving state information of the other vehicle, based on a vehicle identification number corresponding to the call number, and to perform location sharing based on the driving state information such that a location of the vehicle is shared with the other vehicle.

In accordance with a further aspect of the present disclosure, there is provided a location sharing method of a vehicle including receiving a location sharing request with a call number of a mobile terminal from a first vehicle, requesting a second vehicle to transmit driving state information of the second vehicle, based on a vehicle identification number corresponding to the call number, and performing control based on the driving state information such that a location of the first vehicle is shared with the second vehicle.

The location sharing method may further include requesting a first external server to transmit a vehicle ID corresponding to the call number, thereby receiving the vehicle ID, and requesting a second external server to transmit the vehicle identification number corresponding to the vehicle ID, thereby receiving the vehicle identification number.

The location sharing method may further include requesting the first external server to transmit user information corresponding to the call number, thereby receiving the user information.

The performing location sharing may include transmitting the location sharing request of the first vehicle upon determining that the second vehicle is in a driving state, based on the driving state information, and transmitting the location of the first vehicle to the second vehicle upon receiving an approval response of the second vehicle to the location sharing request.

The performing location sharing may further include transmitting a location of the second vehicle to the first vehicle upon receiving the approval response of the second vehicle to the location sharing request.

The location sharing method may further include transmitting the location sharing request of the first vehicle to the mobile terminal, based on the call number, and transmitting the location of the first vehicle to the mobile terminal upon receiving an approval response of the mobile terminal to the location sharing request.

The transmitting the location sharing request of the first vehicle to the mobile terminal may be executed to transmit the location sharing request through a short message service (SMS) including uniform resource locator (URL) link information.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a block diagram showing a configuration of a location sharing system according to an exemplary embodiment of the present disclosure;

FIG. 2 is a block diagram showing a configuration of the location sharing server according to an exemplary embodiment of the present disclosure;

FIG. 3 is a view explaining a method of providing a location sharing service between a vehicle and a mobile terminal by the location sharing server according to the exemplary embodiment of the present disclosure;

FIG. 4 is a view explaining a method of providing an inter-vehicle location sharing service by the location sharing server according to the exemplary embodiment of the present disclosure;

FIG. 5 is a sequence diagram explaining a method of providing a location sharing service by the location sharing system according to the exemplary embodiment of the present disclosure; and

FIG. 6 is a view explaining a method of providing an inter-vehicle location sharing service based on a call number of the mobile terminal by the location sharing server according to the exemplary embodiment of the present disclosure.

### DETAILED DESCRIPTION

Hereinafter, preferred embodiments of the present disclosure will be described in detail with reference to the accompanying drawings, and the same or similar elements are designated by the same reference numerals regardless of the numerals in the drawings and redundant description thereof will be omitted.

In describing the present disclosure, moreover, the detailed description will be omitted when a specific description of publicly known technologies to which the disclosure pertains is judged to obscure the gist of the present disclosure. In addition, it should be noted that the accompanying drawings are merely illustrated to easily explain the spirit of the disclosure, and therefore, should not be construed as limiting the spirit of the disclosure to the accompanying drawings. On the contrary, the disclosure is to cover all modifications, equivalents, and alternatives falling within the spirit and scope of the disclosure as defined by the claims.

In the following description of embodiments, the term “predetermined” means that, when a parameter is used in a process or an algorithm, the numerical value of the parameter has been previously determined. The numerical value of the parameter may be set when the process or the algorithm is begun or during a period in which the process or algorithm is executed in accordance with an embodiment.

In the meantime, although terms including an ordinal number, such as first or second, may be used to describe a variety of constituent elements, the constituent elements are not limited to the terms, and the terms are used only for the purpose of discriminating one constituent element from other constituent elements.

It will be understood that, when one element is referred to as being “connected to” or “coupled to” another element, one element may be “connected to” or “coupled to” another element via a further element although one element may be directly connected to or directly coupled to another element. On the other hand, it will be understood that, when an element is referred to as being “directly connected to” or “directly coupled to” another element, there is no intervening element present.

As used in the description of the disclosure and the appended claims, the singular forms are intended to include the plural forms as well, unless context clearly indicates otherwise.

It will be further understood that the terms “comprises” and/or “comprising,” or “includes” and/or “including” when used in this specification, specify the presence of stated features, regions, integers, steps, operations, elements, and/or combinations thereof, but do not preclude the presence or addition of one or more other features, regions, integers, steps, operations, elements, components, and/or combinations thereof.

A controller may include a communication device configured to communicate with another controller or a sensor, for control of a function to be performed thereby, a memory configured to store an operating system, logic commands, input/output information, etc., and at least one processor configured to execute discrimination, calculation, determination, etc. required for control of the function to be performed.

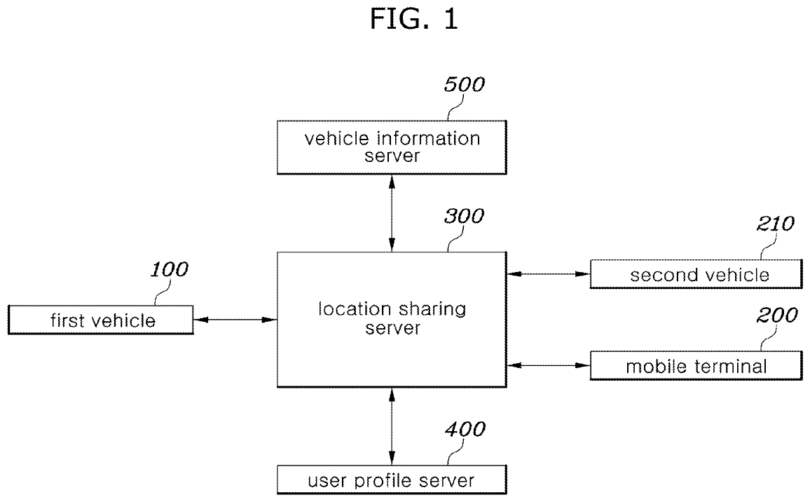

FIG. 1 is a block diagram showing a configuration of a location sharing system according to an exemplary embodiment of the present disclosure.

As shown in FIG. 1, the location sharing system according to the exemplary embodiment of the present disclosure may include a first vehicle 100, a mobile terminal 200, a second vehicle 210, a location sharing server 300, a user profile server 400, and a vehicle information server 500.

In this embodiment, for convenience of description, it is assumed that the first vehicle 100 corresponds to a vehicle of a location sharing requester, the mobile terminal 200 corresponds to a mobile terminal (for example, a smartphone) of a counterpart receiving a location sharing request from the location sharing requester, and the second vehicle 210 corresponds to a vehicle of the counterpart.

The location sharing server 300 may correspond to a server for providing a location sharing service, the user profile server 400 may correspond to a server for managing personal information of the location sharing requester and the counterpart, and the vehicle information server 500 may correspond to a server for managing information of the vehicle of the location sharing requester and information of the vehicle of the counterpart.

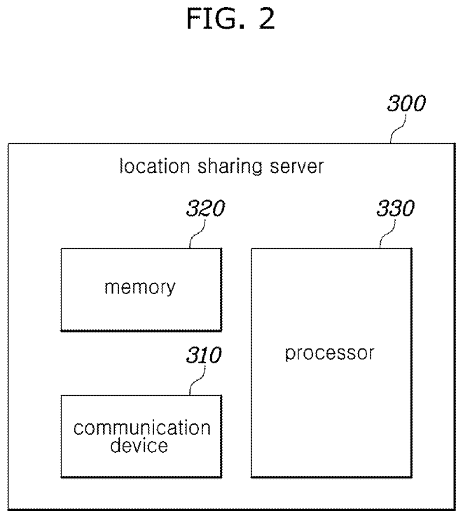

FIG. 2 is a block diagram showing a configuration of the location sharing server according to an exemplary embodiment of the present disclosure.

As shown in FIG. 2, the location sharing server 300 according to the exemplary embodiment of the present disclosure may include a communication device 310, a memory 320, and a processor 330.

The communication device 310 may support wired and/or wireless communication in order to enable the processor 330 to communicate with a vehicle and a mobile terminal which are objects of a location sharing service.

The memory 320 may correspond to a non-transitory storage medium configured to store instructions executed by the processor 330. The memory 320 may further include a non-volatile medium such as a hard disk drive (HDD), a solid state drive (SSD), an embedded multimedia card (eMMC), and/or a universal flash storage (USF).

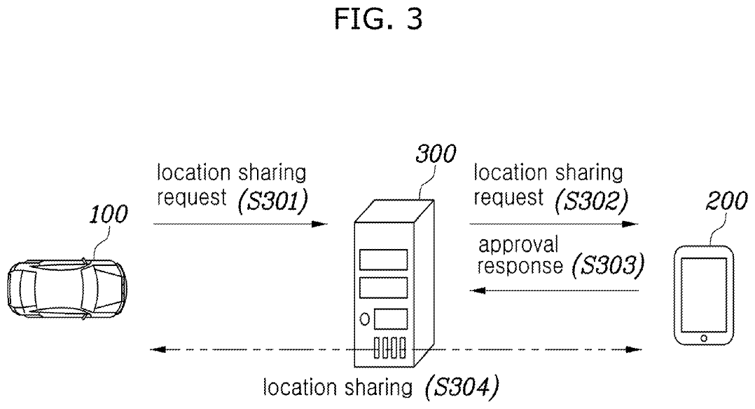

FIG. 3 is a view explaining a method of providing a location sharing service between a vehicle and a mobile terminal by the location sharing server according to the exemplary embodiment of the present disclosure.

Referring to FIG. 3, the first vehicle 100 may transmit a location sharing request with a call number (for example, a telephone number) of the mobile terminal 200 to a processor of the location sharing server 300 (S301). In this case, the first vehicle 100 may communicate with a communication device of the location sharing server 300 via an audio/video/navigation/telematics (AVNT) terminal.

The processor of the location sharing server 300 may transmit the location sharing request of the first vehicle 100 to the mobile terminal 200 via a communication device of the location sharing server 300, based on the call number of the mobile terminal 200 (S302). In this case, the processor of the location sharing server 300 may transmit the location sharing request of the first vehicle 100 to the mobile terminal 200 through a short message service (SMS) including uniform resource locator (URL) link information.

The mobile terminal 200 may transmit an approval response to the location sharing request of the first vehicle 100 to the processor of the location sharing server 300 (S303). For example, when the user of the mobile terminal 200 connects to a URL of the short message service (SMS), the mobile terminal 200 may transmit the approval response to the location sharing request of the first vehicle 100 to the location sharing server 300.

Upon receiving the approval response of the mobile terminal 200, the processor of the location sharing server 300 may perform location sharing such that a current location of the first vehicle 100 is shared with the mobile terminal 200 via the communication device of the location sharing server 300 (S304). In more detail, upon receiving the approval response of the mobile terminal 200, the processor of the location sharing server 300 may periodically transmit a current location of the first vehicle 100 via the communication device of the location sharing server 300. In addition, upon receiving the approval response of the mobile terminal 200, the processor of the location sharing server 300 may periodically transmit a current location of the mobile terminal 200 via the communication device of the location sharing server 300 (S304).

Meanwhile, differently from the case of FIG. 3, the mobile terminal 200 may transmit a rejection response to the location sharing request of the first vehicle 100 to the location sharing server 300 or may be in a state in which the mobile terminal 200 does not respond to the location sharing request of the first vehicle 100. Upon receiving the rejection response of the mobile terminal 200, the processor of the location sharing server 300 may perform control such that the first vehicle 100 and the mobile terminal 200 do not share locations thereof with each other.

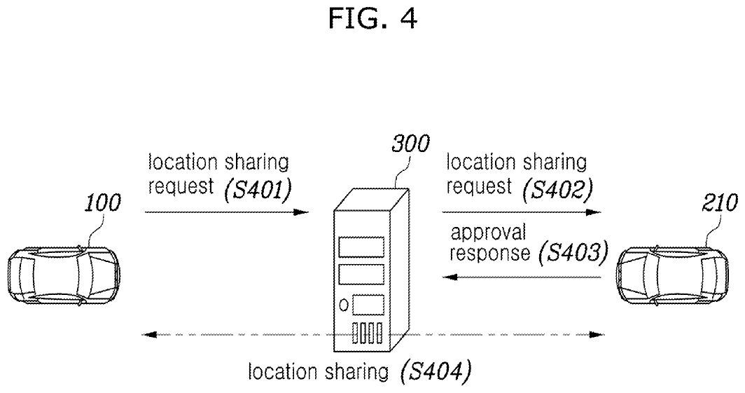

FIG. 4 is a view explaining a method of providing an inter-vehicle location sharing service by the location sharing server according to the exemplary embodiment of the present disclosure.

Referring to FIG. 4, the first vehicle 100 may transmit a location sharing request with a vehicle identification number (VIN) of the second vehicle 210 to a processor of a location sharing server 300 (S401).

The processor of the location sharing server 300 may transmit the location sharing request of the first vehicle 100 to the second vehicle 210 via a communication device of the location sharing server 300, based on the vehicle identification number (VIN) of the second vehicle 210 (S402).

The second vehicle 210 may transmit an approval response to the location sharing request of the first vehicle 100 to the processor of the location sharing server 300 (S403).

Upon receiving the approval response of the second vehicle 210, When the processor of the location sharing server 300 may perform location sharing such that a current location of the first vehicle 100 is shared with the second vehicle 210 (S404). In more detail, upon receiving the approval response of the second vehicle 210, the processor of the location sharing server 300 may periodically transmit a current location of the first vehicle 100 to the second vehicle 210 via the communication device of the location sharing server 300. In addition, upon receiving the approval response of the mobile terminal 200, the processor of the location sharing server 300 may periodically transmit a current location of the second vehicle 210 to the first vehicle 100 via the communication device of the location sharing server 300.

As described above, the user of the location sharing service may share his current vehicle location with a mobile terminal or a vehicle of a counterpart by requesting location sharing to the mobile terminal or the vehicle of the counterpart through a location sharing service.

However, in a scheme in which a location sharing requester selects a node of one of a mobile terminal or a vehicle of a counterpart, and the selected node and the vehicle location of the requester are shared, responsiveness and convenience of a location sharing service for the counterpart may be degraded.

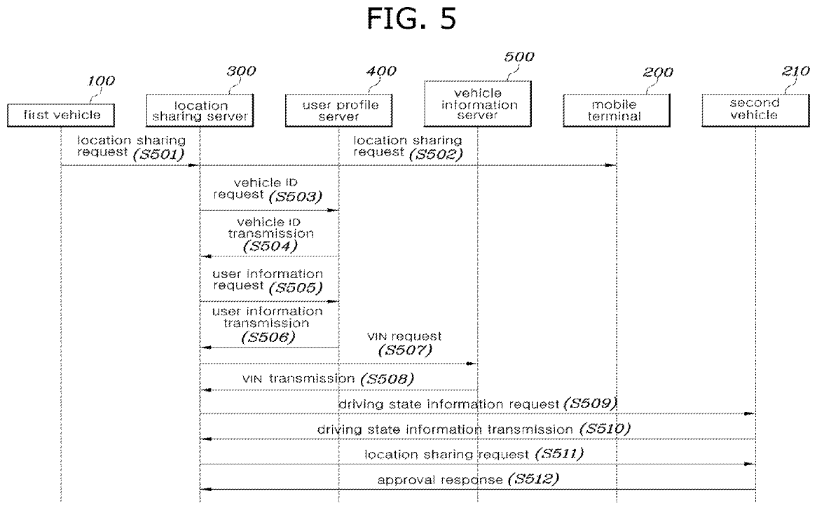

To this end, in accordance with the exemplary embodiment of the present disclosure, a scheme in which, when a vehicle of a location sharing requester requests location sharing to a mobile terminal of a counterpart receiving a location sharing request from the location sharing requester, an inter-vehicle location sharing service is provided in accordance with whether or not a vehicle of the counterpart is in a driving state, based on a call number of the mobile terminal, thereby enhancing responsiveness and convenience of a location sharing service, is proposed. A method of operating this scheme is shown in FIG. 5.

FIG. 5 is a sequence diagram explaining a method of providing a location sharing service by the location sharing system according to the exemplary embodiment of the present disclosure.

Referring to FIG. 5, the first vehicle 100 may transmit a location sharing request with a call number of the mobile terminal 200 to the processor of the location sharing server 300 (S501).

The processor of the location sharing server 300 may receive the location sharing request with the call number of the mobile terminal 200, and may transmit the location sharing request of the first vehicle 100 to the mobile terminal 200, based on the call number of the mobile terminal 200 (S502). In this case, as shown in FIG. 3, the mobile terminal 200 may transmit an approval response to the location sharing request of the first vehicle 100 to the location sharing server 300.

In addition, the processor of the location sharing server 300 may request the second vehicle 210 to transmit driving state information of the second vehicle 210, based on a vehicle identification number (VIN) corresponding to the call number of the mobile terminal 200 (S503 to S509). Upon determining that the second vehicle 210 is in a driving state, based on the driving state information, the processor of the location sharing server 300 may perform location sharing such that a current location of the first vehicle 100 is shared with the second vehicle 210 (S510 to S511).

In more detail, the processor of the location sharing server 300 may request the user profile server 400 to transmit a vehicle ID corresponding to the call number of the mobile terminal 200 (S503). In response to the vehicle ID transmission request, the user profile server 400 may transmit the vehicle ID corresponding to the call number of the mobile terminal 200 to the processor of the location sharing server 300, based on a table in which the call number of the mobile terminal 200 and the vehicle ID are matched with each other (S504). In addition, the processor of the location sharing server 300 may request the user profile server 400 to transmit user information corresponding to the call number of the mobile terminal 200 (S505). In response to the user information transmission request, the user profile server 400 may transmit, to the processor of the location sharing server 300, user information (for example, an e-mail address, a personal identifiable value, etc.) corresponding to the call number of the mobile terminal 200 (S506).

The processor of the location sharing server 300 may request the vehicle information server 500 to transmit a vehicle identification number (VIN) corresponding to the vehicle ID (S507). In response to the vehicle identification number (VIN) transmission request, the vehicle information server 500 may transmit the vehicle identification number (VIN) corresponding to the vehicle ID to the processor of the location sharing server 300 (S508).

The location sharing server 300 may request the second vehicle 210 corresponding to the vehicle identification number (VIN) to transmit driving state information of the second vehicle 210 (S509). In response to the driving state information transmission request, the second vehicle 210 may transmit driving state information of the second vehicle 210 to the processor of the location sharing server 300 (S510). Here, the driving state information may represent whether or not the second vehicle 210 is in a driving state. In this case, the second vehicle 210 may communicate with the communication device of the locating sharing server 300 via an audio/video/navigation/telematics (AVNT) terminal.

Upon determining that the second vehicle 210 is in a driving state, based on the driving state information, the location sharing server 300 may transmit the location sharing request of the first vehicle 100 to the second vehicle 210 (S511).

The second vehicle 210 may transmit an approval response to the location sharing request of the first vehicle 100 to the processor of the locating sharing server 300 (S512).

Upon receiving the approval response of the mobile terminal 200, the processor of the location sharing server 300 may perform location sharing such that the current location of the first vehicle 100 is shared with the second vehicle 210. In more detail, upon receiving the approval response of the mobile terminal 200, the processor of the location sharing server 300 may periodically transmit a current location of the first vehicle 100 to the second vehicle 210 via the communication device of the location sharing server 300. In addition, upon receiving the approval response of the mobile terminal 200, the processor of the location sharing server 300 may periodically transmit a current location of the mobile terminal 200 to the first vehicle 100 via the communication device of the location sharing server 300.

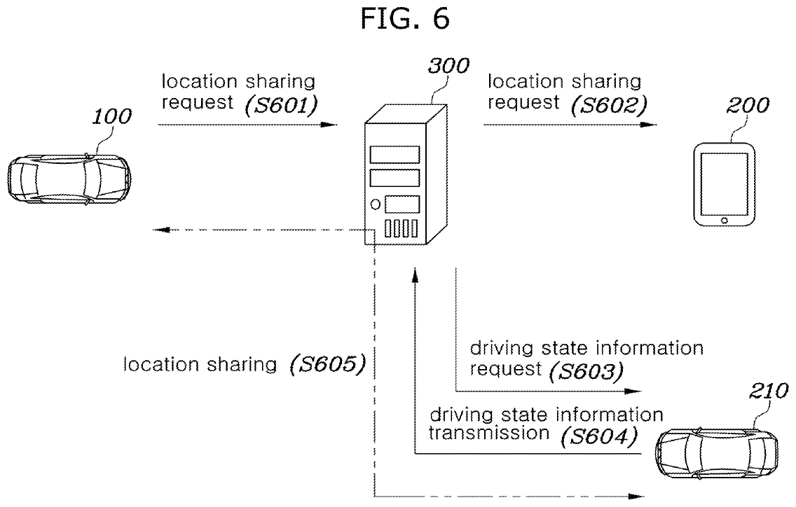

FIG. 6 is a view explaining a method of providing an inter-vehicle location sharing service based on a call number of the mobile terminal by the location sharing server according to the exemplary embodiment of the present invention.

Referring to FIG. 6, the first vehicle 100 may transmit a location sharing request with a call number of the mobile terminal 200 to the processor of the location sharing server 300 (S601).

The processor of the location sharing server 300 may transmit the location sharing request of the first vehicle 100 to the mobile terminal 200 via the communication device of the location sharing server 300, based on the call number of the mobile terminal 200 (S602).

In addition, the processor of the location sharing server 300 may request the second vehicle 210 to transmit driving state information of the second vehicle 210, based on a vehicle identification number (VIN) corresponding to the call number of the mobile terminal 200 (S603).

In response to the driving state information transmission request, the second vehicle 210 may transmit the driving state information thereof to the processor of the location sharing server 300 (S604).

Upon determining that the second vehicle 210 is in a driving state, based on the driving state information, the processor of the locating sharing server 300 may perform location sharing such that the first vehicle 100 and the second vehicle 210 share locations thereof with each other (S605).

As described above, in accordance with the exemplary embodiment of the present disclosure, when a vehicle of a location sharing requester requests location sharing to a mobile terminal of a counterpart receiving a location sharing request from the location sharing requester, an inter-vehicle location sharing service may be provided in accordance with whether or not a vehicle of the counterpart is in a driving state, based on a call number of the mobile terminal, and, as such, responsiveness and convenience of a location sharing service may be enhanced.

Meanwhile, the present disclosure as described above may be embodied as computer-readable code, which can be written on a program-stored recording medium. The recording medium that can be read by a computer includes all kinds of recording media on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc. Accordingly, the above detailed description should be understood as exemplary rather than limiting in all aspects. The scope of the present disclosure should also be interpreted by the claims below. All modifications as would be derived from the equivalent concept intended to be included within the scope of the present disclosure should also be interpreted as falling within the scope of the disclosure.

As apparent from the above description, in accordance with the exemplary embodiment of the present disclosure, when a vehicle of a location sharing requester requests location sharing to a mobile terminal of a counterpart receiving a location sharing request from the location sharing requester, an inter-vehicle location sharing service may be provided in accordance with whether or not a vehicle of the counterpart is in a driving state, based on a call number of the mobile terminal, and, as such, responsiveness and convenience of a location sharing service may be enhanced.

The effects of the embodiments of the present disclosure are not limited to the above-described effects and other effects which are not described herein may be readily understood by those skilled in the art from the appended claims.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A location sharing server comprising:
a memory; and
a processor configured to:
receive a location sharing request with a call number of a mobile terminal from a first vehicle;
request a second vehicle to transmit driving state information of the second vehicle based on a vehicle identification number corresponding to the call number; and
perform location sharing based on the driving state information such that a location of the first vehicle is shared with the second vehicle.

2. The location sharing server according to claim 1, wherein the processor is configured to request a first external server to transmit a vehicle ID corresponding to the call number, thereby receiving the vehicle ID, and is configured to request a second external server to transmit the vehicle identification number corresponding to the vehicle ID, thereby receiving the vehicle identification number.

3. The location sharing server according to claim 2, wherein the processor is configured to request the first external server to transmit user information corresponding to the call number, thereby receiving the user information.

4. The location sharing server according to claim 1, wherein the processor is configured to transmit the location sharing request of the first vehicle upon determining that the second vehicle is in a driving state based on the driving state information, and is configured to transmit the location of the first vehicle to the second vehicle upon receiving an approval response of the second vehicle to the location sharing request.

5. The location sharing server according to claim 4, wherein the processor is configured to transmit a location of the second vehicle to the first vehicle upon receiving the approval response of the second vehicle to the location sharing request.

6. The location sharing server according to claim 1, wherein the processor is configured to transmit the location sharing request of the first vehicle to the mobile terminal based on the call number, and is configured to transmit the location of the first vehicle to the mobile terminal upon receiving an approval response of the mobile terminal to the location sharing request.

7. The location sharing server according to claim 6, wherein the processor is configured to transmit the location sharing request to the mobile terminal through a short message service (SMS) comprising uniform resource locator (URL) link information.

8. A location sharing system comprising:
a vehicle configured to transmit a location sharing request with a call number of a mobile terminal; and
a location sharing server configured to:
receive the location sharing request with the call number from the vehicle;
request another vehicle to transmit driving state information of the other vehicle based on a vehicle identification number corresponding to the call number; and
perform location sharing based on the driving state information such that a location of the vehicle is shared with the other vehicle.

9. A location sharing method of a vehicle comprising:
receiving, by a server, a location sharing request with a call number of a mobile terminal from a first vehicle;
requesting, by the server, a second vehicle to transmit driving state information of the second vehicle based on a vehicle identification number corresponding to the call number; and
performing, by the server, location sharing based on the driving state information such that a location of the first vehicle is shared with the second vehicle.

10. The location sharing method according to claim 9, further comprising:
requesting, by the server, a first external server to transmit a vehicle ID corresponding to the call number, thereby receiving the vehicle ID; and
requesting, by the server, a second external server to transmit the vehicle identification number corresponding to the vehicle ID, thereby receiving the vehicle identification number.

11. The location sharing method according to claim 10, further comprising:
requesting, by the server, the first external server to transmit user information corresponding to the call number, thereby receiving the user information.

12. The location sharing method according to claim 9, wherein performing location sharing comprises:
transmitting the location sharing request of the first vehicle upon determining that the second vehicle is in a driving state, based on the driving state information; and
transmitting the location of the first vehicle to the second vehicle upon receiving an approval response of the second vehicle to the location sharing request.

13. The location sharing method according to claim 12, wherein performing location sharing further comprises:
transmitting a location of the second vehicle to the first vehicle upon receiving the approval response of the second vehicle to the location sharing request.

14. The location sharing method according to claim 9, further comprising:
transmitting the location sharing request of the first vehicle to the mobile terminal, based on the call number; and
transmitting the location of the first vehicle to the mobile terminal upon receiving an approval response of the mobile terminal to the location sharing request.

15. The location sharing method according to claim 14, wherein transmitting the location sharing request of the first vehicle to the mobile terminal is executed to transmit the location sharing request through a short message service (SMS) comprising uniform resource locator (URL) link information.
